(19) United States
(12) Patent Application Publication
(10) Pub. No.: US 2014/0156138 A1
(43) Pub. Date: Jun. 5, 2014

(54) COURTESY CAR MANAGEMENT SYSTEM

(71) Applicant: DEALERFLOW, LLC, Arlington, VA (US)

(72) Inventors: Thomas L. KLAFF, Arlington, VA (US); Paul DIPIAZZA, Silver Spring, MD (US); Tony SIMOPOULOS, Toronto (CA)

(73) Assignee: DEALERFLOW, LLC, Arlington, VA (US)

(21) Appl. No.: 13/706,140

(22) Filed: Dec. 5, 2012

(51) Int. Cl. G06Q 10/02; G06F 17/00

(52) U.S. Cl. CPC G06Q 10/02; G06F 17/00
USPC 701/33.4; 705/5; 701/29.1

(57) ABSTRACT

A method and system for cost-effective management of a plurality of vehicles to be lent or rented, possibly but not limited to a courtesy vehicle fleet. The initial reservation process is divided into two separate stages of reserving a non-specific vehicle and selecting said vehicle, allowing flexibility in selection. The return of the vehicle is efficiently handled through a series of diagnostic checks and damage documentation. Both processes are optionally managed by a series of devices interacting through a network, including a server device which manages data and provides reports on the plurality of vehicles. The overall system and process is tracked and managed through database-driven analytics that give its operators real-time intelligence on fleet status and inventory, as well as customer and billing records.

### BACKGROUND OF THE INVENTION

1. Field of the Invention

Aspects of the present invention include a method and system of managing a courtesy or loaner car fleet, including but not limited to the on-boarding and off-boarding process.

2. Description of the Related Art

As part of the service of automotive repair, a vehicle dealership will sometimes supply a courtesy vehicle to customers, allowing the customers to continue day-to-day life while their personal vehicles are being repaired and/or otherwise unavailable. This requires a system for managing a courtesy vehicle fleet.

Generally, third parties, such as a rental car vendor, offer an outsourced courtesy vehicle program to dealerships. On the one hand, this system removes the headaches associated with managing courtesy vehicles as a strategic operation, but on the other hand, it costs a lot of money to the dealership in per trip fees, and the third party keeps late fees and charges for ancillary services like fuel and insurance. Also, as the dealership does not own the courtesy vehicles, it may not later sell them as pre-owned inventory when phasing them out of the fleet.

Dealerships that manage their own courtesy vehicle fleets may use Excel spreadsheets, which are cumbersome and have virtually no reporting capabilities. Alternatively, they may use a reservation software package, which is integrated into a dealership management system, but requires more trained staff to operate and manage, plus a fleet manager at a rental counter to on-board and off-board customers.

One of the greatest delays in on-boarding is the reservation process itself, which in the prior art includes a lengthy vehicle selection and the completion of a rental agreement before the customer may be issued a key and a formal reservation for the desired period. The on-boarding also requires that a staff-member escort the customer to the selected vehicle.

A reservation system that may be easily operated by a small staff, without excessive training, and with minimal staff involvement in on-boarding and off-boarding, is therefore desirable.

### SUMMARY OF THE INVENTION

While not limited thereto, an embodiment of the invention is directed to a method of granting use of a vehicle from a plurality of vehicles, the method comprising creating a reservation of a presently non-specified vehicle of a plurality of vehicles for a user for a speci ic period of time; and, upon the user's selection of a specific vehicle of the plurality of vehicles, associating the specific vehicle with the customer's reservation.

While not limited thereto, an embodiment of the invention is directed to a system for managing use of a plurality of vehicles, the system comprising said plurality of vehicles; at least one reader associated with each vehicle of the plurality of vehicles; a plurality of authentication objects readable by the readers; a server device comprising a processor, transceiver, and memory, the server device being in communication with the readers through the transceiver; and an advisor device comprising a processor and transceiver of the server device, the advisor device being in communication with the server device through the transceiver of the advisor device; wherein the advisor device creates a reservation in the memory of the server device and associates an authentication object with the reservation, without associating the reservation with a vehicle of the plurality of vehicles, and wherein the authentication object, when brought within a range of one of the plurality of readers, associates, in the memory of the server device, the reservation associated with the authentication object with the vehicle associated with the reader.

While not limited thereto, an embodiment of the invention is directed to a method of processing the return of a lent or rented vehicle, comprising, at the conclusion of the rental or lending period, examining a series of present diagnostic parameters related to a lent or rented vehicle; comparing present diagnostic parameters to previous diagnostic parameters in a diagnostic history; and in a case where a change between present diagnostic parameters and previous diagnostic parameters is noted, updating the diagnostic history to reflect the change.

While not limited thereto, an embodiment of the invention is directed to a system for managing the return of a lent or rented vehicle, the system comprising one or more vehicles; a server device comprising a processor, transceiver, and memory; and a porter device comprising a processor and transceiver, the porter device being in communication with the server device through the transceiver of the porter device, wherein the porter device processes a checklist documenting one or more diagnostic parameters relating to the vehicle, the server device receives and stores the checklist from the porter device, and the porter device compares the checklist to one or more previous checklists stored on the server device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a system for on-boarding and off-boarding customers of a courtesy car fleet, according to an aspect of the invention.

FIG. 2 is a flowchart of a first stage of a method of commencing a courtesy car reservation, where the paperwork and rental agreement are completed, according to an aspect of the invention.

FIG. 3 is a flowchart of a second stage of a method of commencing a courtesy car reservation, where the customer selects a vehicle, according to an aspect of the invention.

FIG. 4 is a flowchart of a method of off-boarding a customer of a courtesy car reservation, according to an aspect of the invention.

FIGS. 5A through 5G depict embodiments of the on-boarding application interface, according to aspects of the invention.

FIGS. 6A through 6F depict embodiments of the off-boarding application interface, according to aspects of the invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

Although the embodiments below describe aspects of the invention in terms of a courtesy car fleet at a dealership, it will be readily apparent to those skilled in the art that the same invention may be applied to any business that lends or shares goods of common utility, including but not limited to rental car dealers, rental truck suppliers, rental equipment services, or public storage facilities, among many kinds of other businesses. It will also be readily apparent that the beneficiaries and users of the invention may be customers, clients, employees, or any other person making use of the goods, for pay, as a benefit, or otherwise.

### 1. Arrangement of the System

According to an aspect of the invention, a courtesy car management system takes the form of a web-based solution used by car dealerships to cost-effectively manage their in-house courtesy vehicle programs.

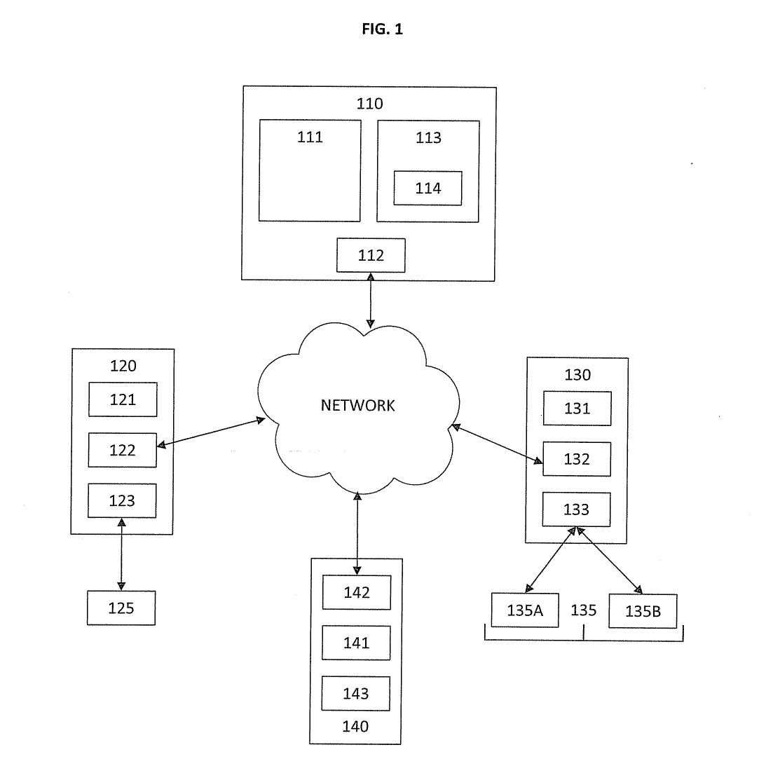

According to an aspect of the invention depicted in FIG. 1, a computer server 110 comprises a processor 111, a transceiver 112, and a memory 113. While not required in all aspects, in the shown embodiment the memory 113 comprises a database 114.

It is understood that FIG. 1 does not depict a physical position of any component in relation to its subcomponents or to other components in the system, or of the subcomponents to each other, but merely expresses which components are subcomponents of other components, and the manner in which the components interact with each other.

In the shown embodiment, the server transceiver 112 communicates through a network or cloud with other transceivers 122, 132, and 142 interacting with a vehicle 120, an advisor device 130, and a porter device 140, respectively. The transceivers 112, 122, 132, and 142 are not limited and may be appreciated by those skilled in the art, but can include hardware capable of interacting with wired and wireless networks, mobile phone networks, or the Internet, or a USB port or other data port. It may be assumed that, when this description refers to any first component transmitting or communicating data to any separate second component, if no path for the data is described, that the path is from the first component through the first component's transceiver, through the network or cloud, and finally through the second component's transceiver to the second component.

The server 110, vehicle 120, advisor device 130, and porter device 140 are also associated with processors 111, 121, 131, and 141, respectively. It may be assumed that, when this description refers to any of these components executing a programmable instruction, if no other method or component is described, that the processor for the given component is executing the instruction. Furthermore, when the description generically refers to “the system” executing a programmable instruction, if no other method or component is described, it may be assumed that any of the processors may execute the instruction depending on the embodiment.

In the shown embodiment, the vehicle 120 is associated with an object reader 123, which is connected to the transceiver 122; the connection may be either direct or through the processor 121. The processor 121 is capable of executing instructions to release certain security features of the vehicle 120, and may in various embodiments have other functions as well.

The object reader 123 is capable of detecting and reading data from an authentication object 125 when said authentication object 125 is brought within a detectable range of the object reader 123. The object reader 123 may then communicate this data, in some instances with other information and instructions, through the transceiver 122 and network to other transceivers in the system. The detectable range may be such that actual contact between the reader 123 and the object 125, or even insertion, is required, or it may be sufficient for them to be brought within a set proximity of each other. Great proximities, however, may create risk that more than one reader 123 will detect the object 125 at the same time; it may therefore be desirable to tailor the proximity to reflect the expected distance between the readers 123 or vehicles 120.

The authentication object 125 may be any portable object from which identifying data may be read. Authentication objects 125 may possess features including but not limited to an RFID chip, microchip, QR code or other bar code, an encoded magnetic stripe, or a data port. Possible authentication objects 125 therefore include, but are not limited to, an RFID card, a security token key fob, or a USB device. Likewise, the object reader 123 may be any device capable of reading data from the corresponding authentication object 125. The object reader 123 may be attached to the interior or exterior of the vehicle 120, or it might be located within a short proximity of the vehicle 120's location. If the object reader 123 is not attached to the vehicle 120, the processor 121 and transceiver 122 might also be separate from the vehicle 120 and instead attached to the object reader 123, or the object reader 123 might have a separate processor and transceiver (not depicted in FIG. 1).

The authentication object 125 may, in some embodiments, be a literal key, in which case the object reader 123 may be a door lock, an ignition lock, or both. The key may include an embedded microchip that contains data, or it may be a traditional key; in the latter case, the identifying data on the key may be limited to the fact that it fits the lock in question.

The authentication object 125 need not be physical. As one example, in some embodiments, the authentication object 125 may be a digital communication, including but not limited to a phone call, text message, or email, and the object reader 123 may be a communication receiver. In such embodiments the detectable range may be the range of the receiver, or even the range of a network with which the receiver communicates. The object reader 123 may also, in some of these embodiments, be combined with the vehicle transceiver 122. The digital communication may be sent from a device under the control of either a customer or a service advisor (SA), including the advisor device 130. In related embodiments, a mobile device that contains and transmits such a digital communication may serve as the authentication object 125.

In the shown embodiment, the advisor device 130 is associated with a card reader 133, which is connected to the transceiver 132; this connection may be either direct or through the advisor device 130. The card reader 133 is capable of reading data off of one or more types of “cards” 135. The card reader 133 may then communicate this data and other information and instructions to the advisor device, or through the transceiver 132 and network to other transceivers in the system. The term “card” is used for convenience, as in the context of vehicles and transactions it may be desirable for the card or cards 135 to be a driver's license with a magnetic stripe or QR code, a credit card, or both; nonetheless, in various embodiments the card 135 may be any object upon which data may be encoded, including any type of object that could function as an authentication object 125. In the embodiment depicted in FIG. 1, two types of cards 135A and 135B may exist, while in others a single card may be sufficient, or three or more may be required. In some embodiments, the card reader 133 and cards 135 may be excluded, in which case any necessary information may be manually entered into the advisor device 130.

In the shown embodiment, the porter device 140 comprises a camera 143, which is connected to the transceiver 142; this connection may be either direct or through the porter device 140. The camera 143 may take digital photographs and communicate them to the server 110. In some embodiments, the camera 143 may be a separate device with its own processor and transceiver (not depicted in FIG. 1).

In some embodiments, the system may interact or be integrated with a Dealer Management System (DMS) (not shown), a software program for vehicle dealerships that may, among other features, manage and track spending, issue purchase orders, manage and order parts inventory, schedule customer repair appointments, or issue repair orders. Such software is known in the prior art and will not be described in detail. The DMS may be installed on the server 110 or other devices within the system, or may be located outside the system but in communication with it through one or more of the transceivers 112, 122, 132, and 142. Data stored within the DMS may be used in any operation of the methods described below when said operation calls for data input, and data produced by the system may be copied to the DMS at any point.

It is understood that the server 110 may be any device with a processor 111, a transceiver 112, and a memory 113; that the advisor device 120 may be any device with a processor 121 and a transceiver 122; and that the porter device 130 may be any device with a processor 131 and a transceiver 132. These may include but are not limited to desktop computers, laptops, tablets, smart phones, or server towers. Furthermore, in some embodiments, one or more of the server 110, advisor device 130, and porter device 140 may be the same device.

Although an aspect of the invention as depicted in FIG. 1 displays only one of each type of component, it is understood that various embodiments of the system may include any number of each component, including more than one subcomponent for each component—e.g., more than one porter device 140 in the system, more than one transceiver 112 interacting with a given server 110, more than one network interacting with one or more of the other components, and so forth.

### 2. On-Boarding

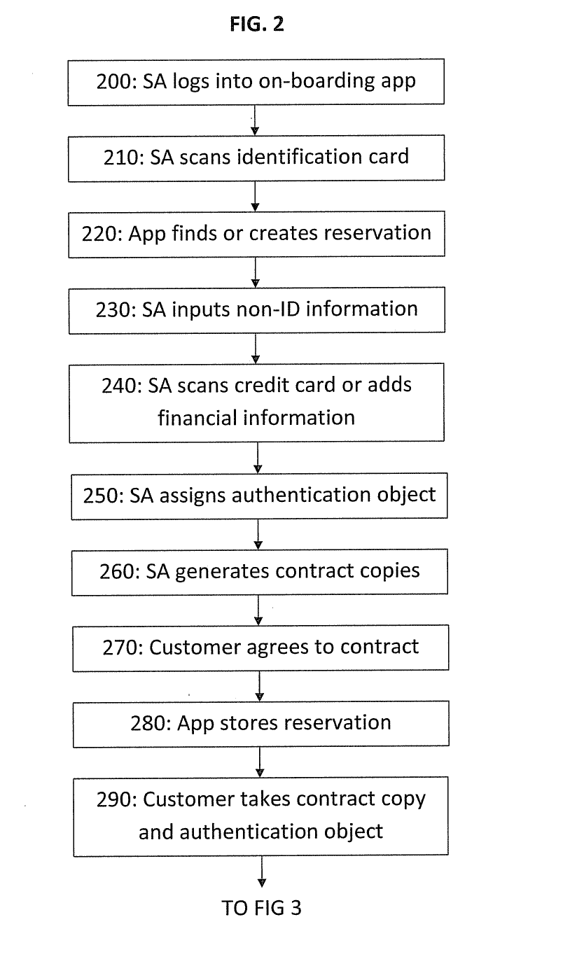

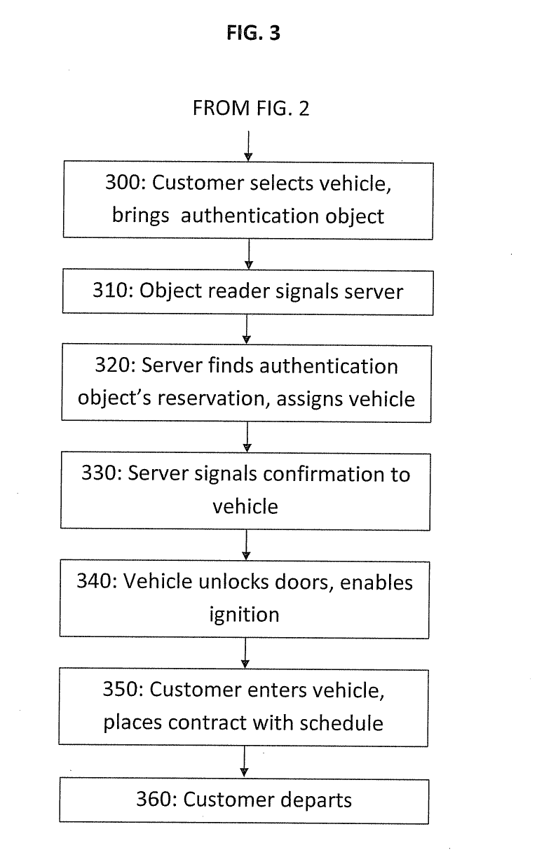

According to an aspect of the invention, one embodiment of which is depicted in FIG. 2, a service advisor (SA) can on-board customers using a courtesy car management solution on-boarding application. The application interacts with the server 110 through the network and records past and present reservations in the memory 113. The application may be programmed onto the server 110 itself, or part or all of it may be programmed onto the vehicle 120 or object reader 122, advisor device 130, and/or porter device 140. Likewise, the application may be processed in part or whole by any of the processors 111, 121, 131, and/or 141. In some embodiments, the application may be part of or integrated with a Dealer Management System (DMS). While the term “application” is used for convenience, it will be appreciated by those skilled in the art that the required instructions may be encoded in any useful format that can be processed by a computer processor.

In the embodiment depicted in FIG. 2, the SA logs into the application using the advisor device 130, at 200. The SA then scans an identifying card 135A of the customer, such as a driver's license, using the card reader 133, at 210. Identifying information of the customer is read from the identifying card 135A. In some embodiments, an existing reservation may already exist with all needed information before this point in some cases; if this is a possibility, the server memory 113 is searched at 220 for a reservation matching the identifying information. If such a reservation exists, the SA may skip to 240. If not, the system generates a reservation for the customer at 220 using the identifying information, and the SA adds non-identifying information, such as the time period of the reservation, at 230.

At this point, the SA may also in some embodiments scan the customer's credit card 135B into the card reader 133, at 240, as a requirement of the car reservation. This requirement may be in order to satisfy vehicle insurance policies, and/or as a means of billing for the reservation or for violations of the terms of service, among other possibilities. If no such requirement exists, the SA may skip to 250.

At 250, the SA selects an authentication object 125 and assigns it to the reservation by inputting information from the authentication object 125 into the advisor device 130. In various embodiments, this may be done by scanning the authentication object 125 in the card reader 133 or by manual input.

In embodiments where the authentication object 125 is a digital communication, this operation 250 may involve instead inputting information from the advisor device 130, for instance some or all of the reservation data, into the digital communication. In embodiments where the authentication object 125 is a mobile device that transmits such a digital communication, the digital communication may be stored on the mobile device at this time or at a later point in the process. In embodiments where the vehicle is known (not shown), one or more of the vehicle ID, VIN, or license plate number may be entered into the advisor device 130 and assigned to the reservation and customer.

At 260, the advisor device creates a contract (not depicted in FIG. 1) using the provided information, and generates two copies. In the shown embodiment, in lieu of describing a vehicle, the contract includes one or more references to a “schedule” that will describe a vehicle, this schedule not being included with the contract as of 260. In other embodiments where the vehicle is known, this reference to a schedule may be removed, and the contract may already include the make, model and VIN of the vehicle. In some embodiments the contract copies may be printed to paper, while in other embodiments the advisor device may provide electronic contracts; the form is unimportant so long as it is portable. The customer agrees to the contract at 270, and the SA retains one copy.

The reservation with all provided information is now, at 280, stored as searchable data in the server memory 113. While in the shown embodiment, all storage occurs after 270, it is understood that the advisor device 130 may store data recognizing the existence of a reservation as early as 220, and add details to this piece of data as they are provided at 230, 240, 250, and 270, such that operation 280 may be effectively completed at an earlier stage in the process.

Finally, the customer takes the second contract copy and the authentication object 125, at 290. At this point of the shown embodiment, no specific vehicle has been selected to associate with the reservation and neither contract designates a vehicle, yet the reservation exists and the SA's involvement in the process is complete.

According to an aspect of the invention, one embodiment of which is depicted in FIG. 3, a customer may, after the process in FIG. 2 is completed, select a vehicle 120 using the courtesy car management system, without further involvement from other parties.

The customer begins, at 300, by selecting a vehicle 120 and bringing the authentication object 125 within a detectable range of the vehicle's object reader 123. In embodiments where the authentication object 125 is a digital communication, or a mobile device that transmits such a digital communication, operation 300 comprises transmitting the digital communication, and may also comprise adding vehicle-identifying information to the communication before transmitting. The object reader 123 reads data off the object 125 and communicates it to the server 110, along with the identity of the vehicle 120, at 310. In the shown embodiment, the server 110 locates, within memory 113, the reservation associated with the object 125, and associates the vehicle 120 with the same reservation, at 320.

At 330, the server 110 transmits a signal back to the vehicle 120, approving the data object 125. In the event that no reservation associated with the data object 125 can be found in memory 113 at 320, or in the event that the vehicle is listed in memory 113 as associated with another reservation, the server 110 may instead return an error at 330, aborting the process and forcing the customer to start again from 300. In some embodiments, the server 110 may not perform one or both checks, or may alternatively perform additional checks.

Upon receiving approval from the server 110—in at least some embodiments, in the context that the reservation is valid and the vehicle is available—the vehicle 120 unlocks its locks and enables its ignition at 340. In some embodiments, only one or the other may be necessary, or another method of preventing unauthorized use may be employed, including but not limited to wheel clamps or physical barriers that may be remotely released.

The customer now enters the vehicle 120 at 350 and joins the contract with a schedule within and associated with the vehicle (not depicted in FIG. 1). This schedule, placed in a secure compartment in the vehicle such as a glove compartment, contains information specific to the vehicle 120 including but not limited to make, model, license plate number, and VIN, and when combined with the contract makes said contract exclusive to the vehicle. In embodiments where the contract is printed on paper, the schedule is as well, and the two may be easily joined using a paper clip or shared envelope. The combination constitutes a legally valid reservation agreement and temporary registration agreement.

At this point of the shown embodiment, at 360, the second stage of the reservation process is complete and the reservation, previously generic, has been properly associated with a specific vehicle 120. The customer may now depart with the vehicle 120, without further inspection.

### 3. Off-Boarding

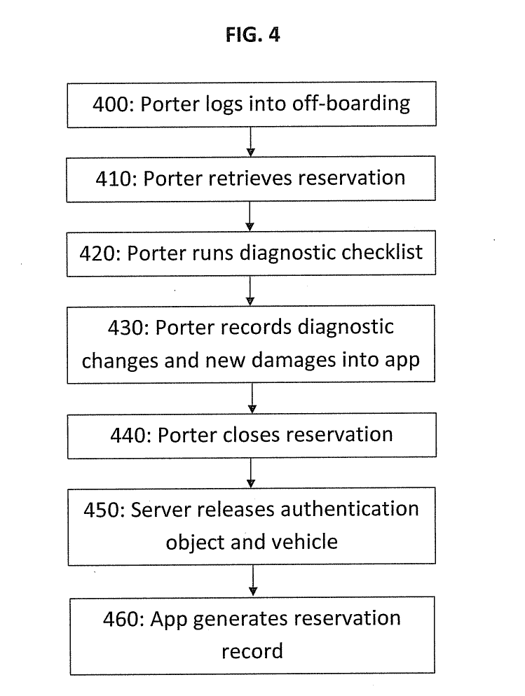

According to an aspect of the invention, one embodiment of which is depicted in FIG. 4, a porter may, upon return of a vehicle, process the return using the courtesy car management system in a rapid manner.

The porter first logs into the off-boarding application, at 400, using the porter device 140. The porter then searches for the reservation of the returned vehicle at 410 within the server memory 113; the basis of this search may include but is not limited to information on the authentication object 125, the ID card 135A, the vehicle 120, or the contract.

The porter now runs a diagnostic checklist at 420, examining the condition of the vehicle 120. The checklist may examine several parameters, including but not limited to fuel level, vehicle cleanliness, need for maintenance, new damage, presence of equipment, or tardy return. All these parameters may be compared to the previous record of the same parameters of the vehicle, as recorded in a diagnostic history of the vehicle stored on the server memory 113. Depending on the status of the parameters, by themselves or as compared to the previous record, in some embodiments billable instances may be generated, which may include but are not limited to low fuel charges, late day charges, cleaning charges, or other items. When the new diagnostic checklist is complete, some or all changes to the diagnostic parameters may be added to the diagnostic history at 430.

If damages are found, the porter may in some embodiments record them in detail into a vehicle damage history report (VDHR) at 430. The interface to create the VDHR may include easy-to-click or touch radial dials and/or pre-configured dropdown-box selections. This VDHR may include but is not limited to location of the damage, level and type of damage, and photographs. The photographs may be taken using the porter device's camera 143. Because previous VDHRs were documented in the same manner into the diagnostic history, the porter may distinguish new damage from old.

Once the checklist is complete, the porter closes the reservation at 440. This sends a signal to the server 110 to release, in memory 113, both the vehicle 120 and the authentication object 125 for future use in another reservation, at 450. The application then generates a reservation record at 460, detailing the complete reservation; this record may in some embodiments also detail any generated billable instances. This record may in some embodiments be optionally printed, or exported to a digital file, for the customer's records.

The reservation thus completed, the vehicle 120 is free for maintenance, cleaning, and/or another reservation. The authentication object 125 is likewise returned to the pool for reuse.

### 4. Fleet Analytics

According to an aspect of the invention, the server 110 may store in memory 113 detailed records about the vehicles 120 in the vehicle fleet, and present the records either directly or summarized in the form of reports. These records and reports may be presented to other devices, including but not limited to the advisor device 130 and porter device 140, on request; they may also be sent to a printer, or exported to a portable file. These records may also be stored in the Dealer Management System (DMS), if one is present, although separate software on the server 110 may process the records for presentation.

In some embodiments, the record for each vehicle 120 may include a “state” which is either “On-Boarding” or “Off-Boarding.” In such embodiments, “On-Boarding” is defined as “a driver has currently claimed the vehicle”, and may be further divided into “On Loan” and “Late Return”. “Off-Boarding”, meanwhile, is defined as “no driver has currently claimed the vehicle”, and may be further divided into “Available” and “Maintenance”. It will be appreciated by those skilled in the art that not all these states and sub-states are required, and that furthermore other states and sub-states are possible.

The server may change a vehicle's state from “Off-Boarding: Available” to “On-Boarding: In Reservation” when it assigns the vehicle to a reservation at 320 in the on-boarding process. A change from “On-Boarding: On Loan” to “On-Boarding: Late Return” may, in some embodiments, be automatic if the reservation time expires before a porter closes the reservation at 440.

In some embodiments, when a porter closes the reservation at 440, he may, via the porter device 140, directly set the status of the vehicle to any of the Off-Boarding states. In other embodiments, one or more of the changes may be automatic should the porter submit a new VDHR or mark certain parameter changes at 430; this may or may not require approval of the status change by a service manager.

Should the vehicle be returned with the maintenance light active, or with damage, the server may set the vehicle state to “Off-Boarding: Maintenance” until such time as the vehicle is ready for use again. It may in some embodiments be desirable to distinguish mere maintenance from damage, creating the need for a third “Off-Boarding: Damage” state.

In some embodiments, it is sufficient that the reservation is closed at 440 to place the vehicle in the “Off-Boarding: Available” state; however, in others, the porter or another employee may first refuel, wash, or store the vehicle, or some combination thereof, before changing the state to “Off-Boarding: Available”; in such cases a fourth, “Off-Boarding: Preparation” sub-state may be desirable.

In various embodiments, other data contained within a vehicle's report in the server memory 113 may include but is not limited to the VIN number, vehicle license plate, make, model, year, mileage, days in service in the fleet, and next scheduled maintenance. The report may also include a list of reservations that have been assigned to the vehicle, past and present; the data for each reservation may include but is not limited to reservation ID number, start time, expected return time, actual return time, mileage used, driver, driver's license, SA who created the reservation, porter who closed the reservation, off-boarding parameters, and the VDHR. The report may also include a list of maintenance work and/or repairs; the data for each such maintenance work and/or repair may include but is not limited to date, expense, and type of maintenance or repair.

According to an aspect of the invention, the server 110 may provide various forms of reports describing the number or percentage of vehicles in the fleet that are listed as in each state or sub-state. Such a report may, in various embodiments, take the form of simple charts such as pie charts, or the form of detailed vehicle lists or data spreadsheets. In at least one embodiment, the server 110 may also predict, based on expected return times, the availability of the fleet at a specific point in the future. The server 110 may also, in some embodiments, present the contents of a specific vehicle's report in innumerable forms, depending on the data desired. Depending on the data to be emphasized, it may be desirable to color code the data.

According to an aspect of the invention, the server memory 113 may also store billing information for each reservation, which may include but is not limited to amount of the bill, paid or unpaid status, date incurred, date due, interest incurred, and reason for the bill. This billing information may alternatively be stored in connection with a driver, a vehicle, or SA. A report may therefore be presented listing all outstanding bills in connection with a vehicle, driver, SA, or specific reservation. In some embodiments, an employee such as an SA or porter may interface with the billing information to report a bill paid or forgiven.

In some embodiments, the server 110 may also provide, on request, a report of a specific reservation to the driver associated with that reservation. The server 110 may further provide, on request, a report of all reservations or of all bills associated with the driver. The server 110 may further provide, if the driver requests so in advance, alerts of an approaching deadline to return a vehicle or pay a bill; such an alert may be sent in numerous forms, including but not limited to text messages, emails, or automated phone calls, or the same may be provided to an employee such as an SA or porter who will communicate with the driver.

In some embodiments, fuel may be precisely measured through use of a fuel sensor within each vehicle 120; the fuel sensor (not depicted in FIG. 1) transmits the fuel level through the transceiver 121 to the server 110. The present fuel level may then be included in the vehicle data and/or the reservation data stored in memory 113, and a desirability of the porter to note the fuel level at 420 may be eliminated.

It will be appreciated by those skilled in the art that this is but a small subset of the possible information that may be stored in the server memory 113 and included in a requested report.

### 5. Exemplary Embodiment

A specific embodiment of the invention will now be described in detail. It is understood that this embodiment is only exemplary and does not limit the scope of the invention.

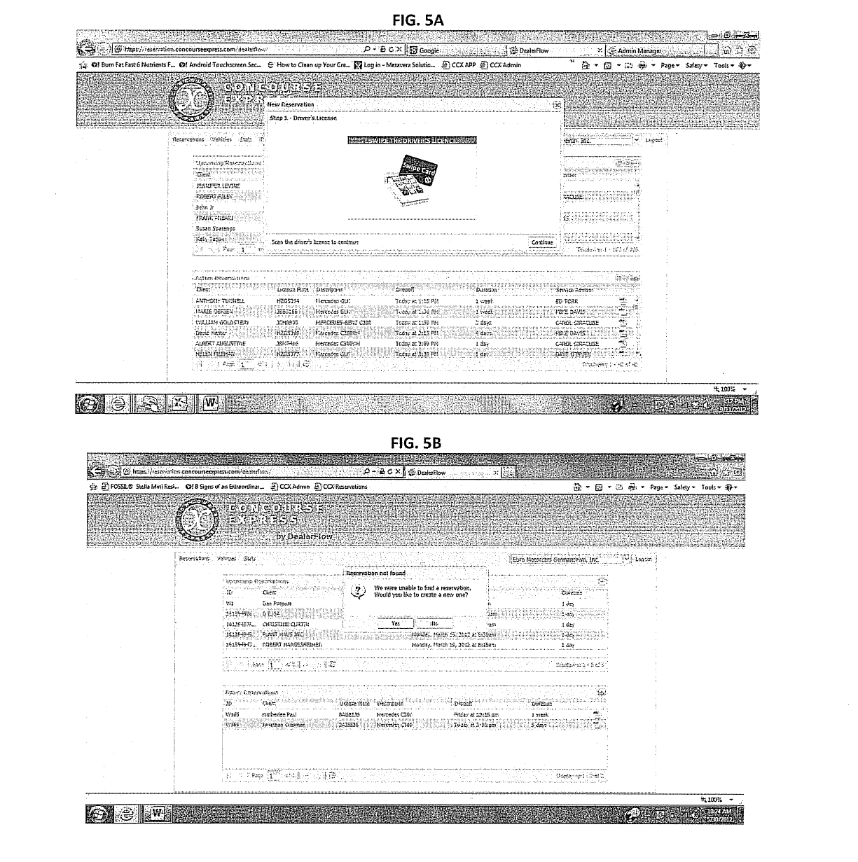

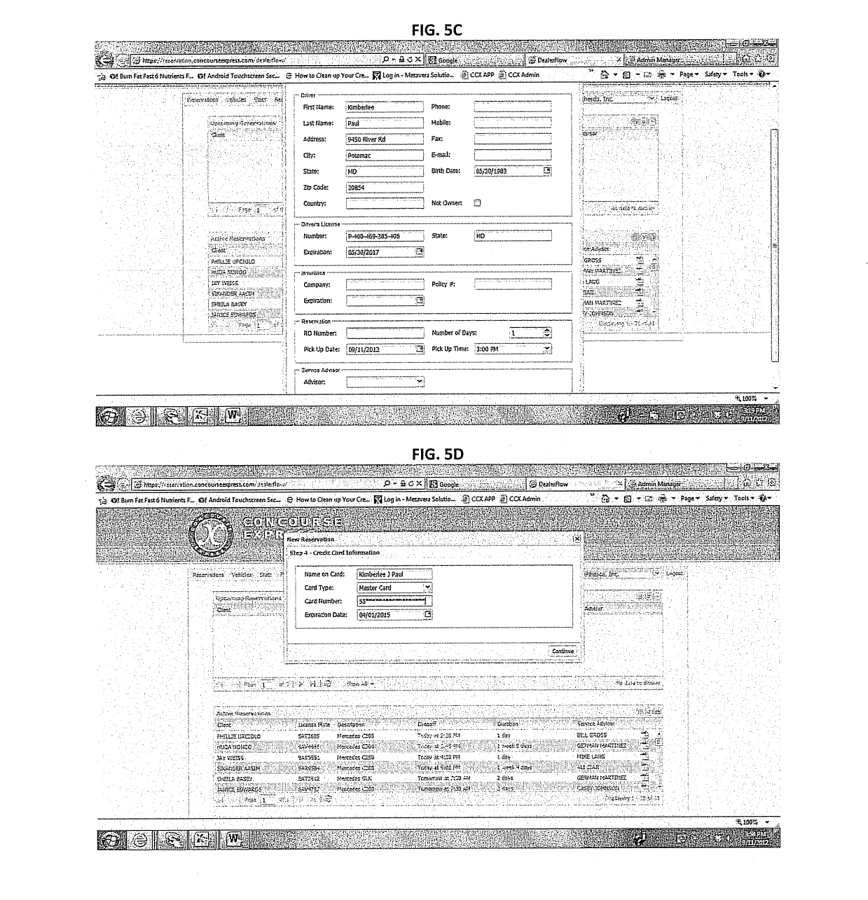

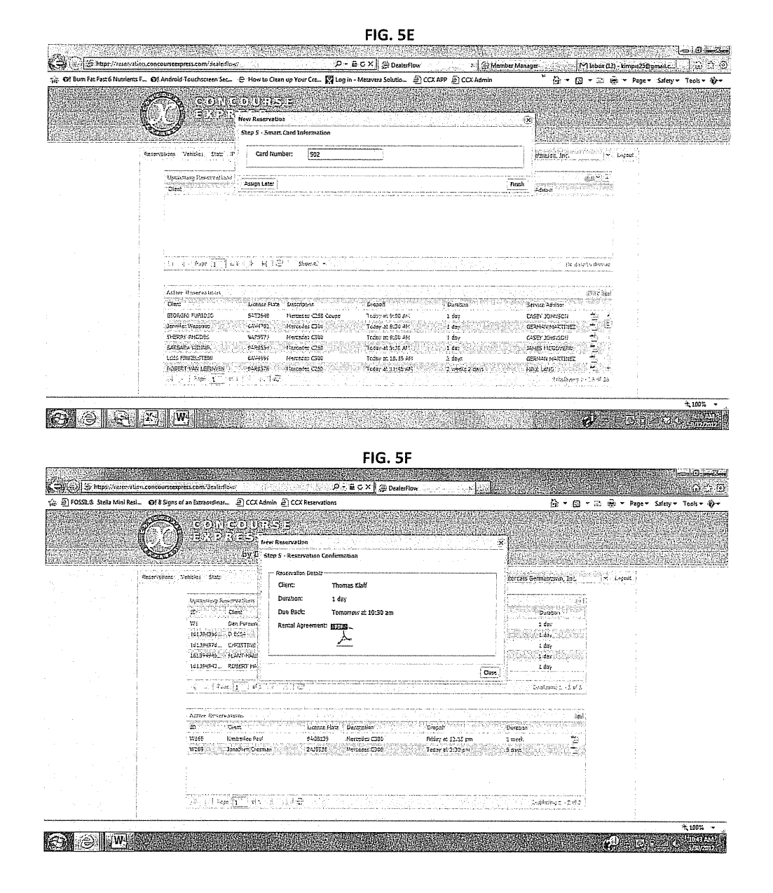

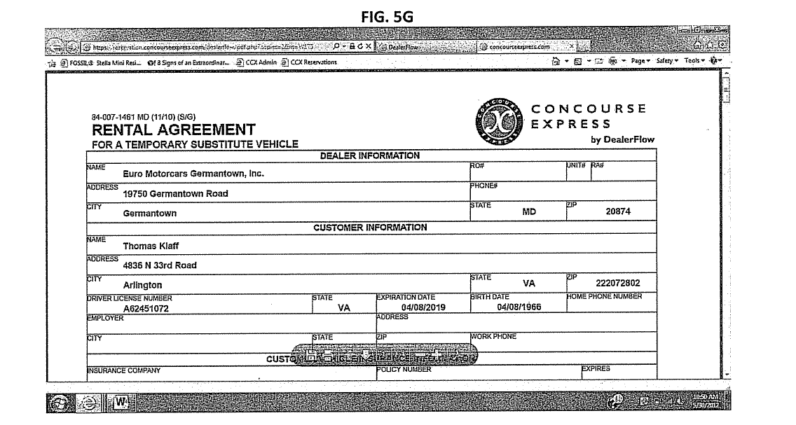

FIGS. 5A through 5G depict a particular embodiment of the on-boarding application. First, as shown in FIG. 5A, the SA (at 210) swipes the customer's valid driver's license 135A through a dual card reader 133 connected to the SA's computer 130 to either bring up a reservation in the system or, as shown in FIG. 5B, initiate a new reservation (at 220). The dual card reader software integrates with the on-boarding application so that the information on the driver's license can be automatically transcribed to the reservation fields without typing. If the driver's license has expired, the application will note this via an error message.

Second, as shown in FIG. 5C, information on the driver and reservation is displayed. The customer's phone number, email address, insurance information (carrier name, policy number and expiration date) and Repair Order number may either be automatically transcribed from the memory 113 of the server 110, which includes regularly scheduled downloads of customer information pulled from a dealership's Dealer Management System (DMS), or it may be typed in to their respective fields by the SA (at 230). A desired duration of the reservation is manually specified in a drop-down box field. Additional drivers may be added to the reservation either from the memory 113 or by repeating the same process with an additional driver's license.

Third, as shown in FIG. 5D, the SA swipes the customer's valid credit card 135B (at 240) and the credit card information is automatically recorded, including the name on the credit card, the credit card type, the card number, and the expiration date. This information is safely stored on the server 110 and may be copied to the DMS, both of which are in a hosted PCI compliant data warehouse.

Fourth, as shown in FIG. 5E, the SA clicks “Continue” and enters the access card number located on the face of the access card 125 (in FIG. 5E, called “smart card”) that he will be handing to the customer (at 250). He then clicks “Finish”.

Fifth, as shown in FIG. 5F, the SA sees the reservation confirmation (at 280) and clicks the PDF icon to display the rental agreement.

The last operation (at 260) has the SA print two (2) copies of the rental agreement. In at least some embodiments, the SA may also print the latest vehicle damage history report (VDHR). The rental agreement, which is shown in part at FIG. 5G, has been approved by the dealership's insurer and complies with the manufacturer's courtesy loaner program guidelines as well as the rental agreement terms and conditions authorized by the State. The following fields are auto-populated: Dealer Information; Customer Vehicle/Insurance Information, and Rental Information. Under “Rental Information”, the term “See Schedule A” is found in the following fields: Rental Vehicle (Year, Make Model, Color); License Plate Number; and Vehicle Identification Number (VIN). The “Schedule A” term is used because the customer has yet to select a vehicle. The last section of the contract is the State Notice Information which requires the driver's signature and below the signature line, the driver is to initial next to the four (4) policies mandated by the dealership: Late Return Policy; Gas Policy; Pre-Existing Car Damage Policy; and No Pets and Smoking Policy.

The customer signs and initials one of the contracts (at 270). The customer retains the unsigned copy and the SA keeps the signed copy on file at the dealership. The SA hands the driver his access card 125 (at 290) and instructs him to take any vehicle staged in the service lane that has the appropriate logo on the windshield.

With an access card and rental agreement in hand, customers can approach any staged courtesy vehicle 120 with the appropriate logo on its windshield. Holding the access card 125 over the RFID reader 123 mounted on a vehicle's driver-side windshield (at 300), the customer activates his reservation once the RFID reader 123 beeps and unlocks the vehicle's doors. Over the Internet, a message is sent to the server 110 (at 310) that reserves that vehicle 120 with the access card 125 assigned to that customer (at 320). The server 110 then transmits the reservation whitelist to the RFID reader 123 (at 330). The whitelist is stored in the RFID reader's cache and prevents anyone with a different access card number from scanning into the vehicle 120, unlocking its doors, and enabling its ignition system. Once the whitelist is delivered to the vehicle, server 110 updates the reservation and associates it with the newly activated vehicle. The server 110 also updates the rental agreement, as stored in memory 113, with the vehicle's VIN and license tag number.

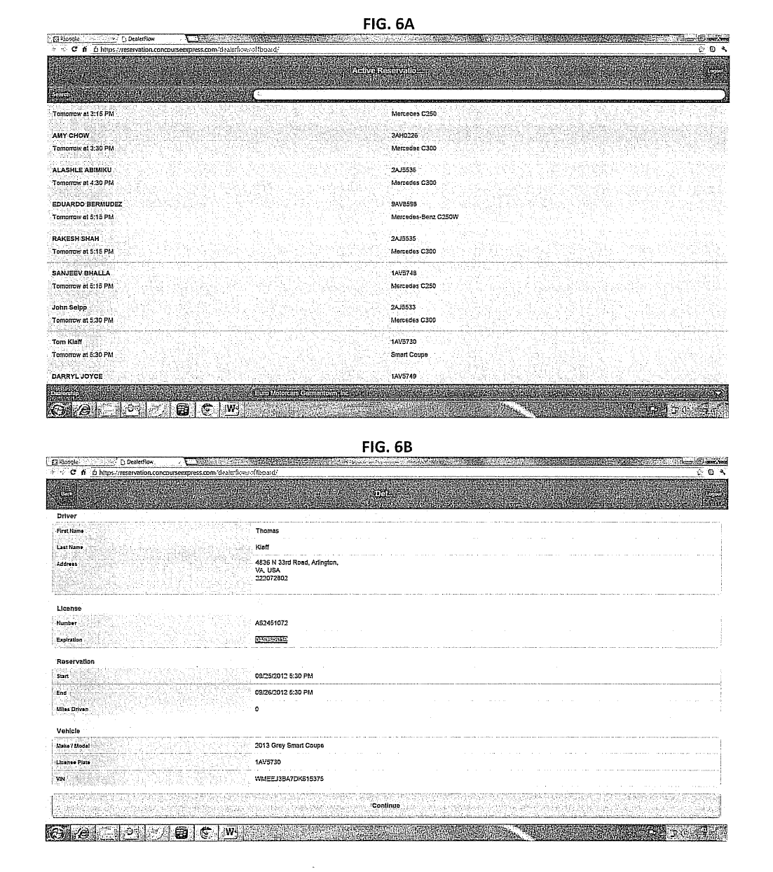

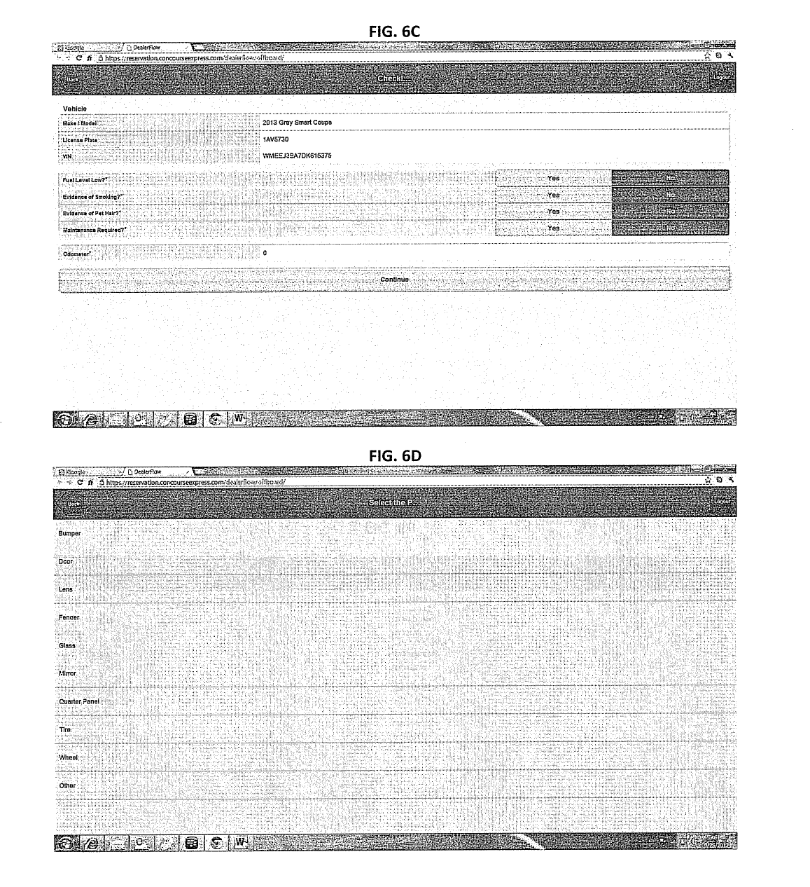

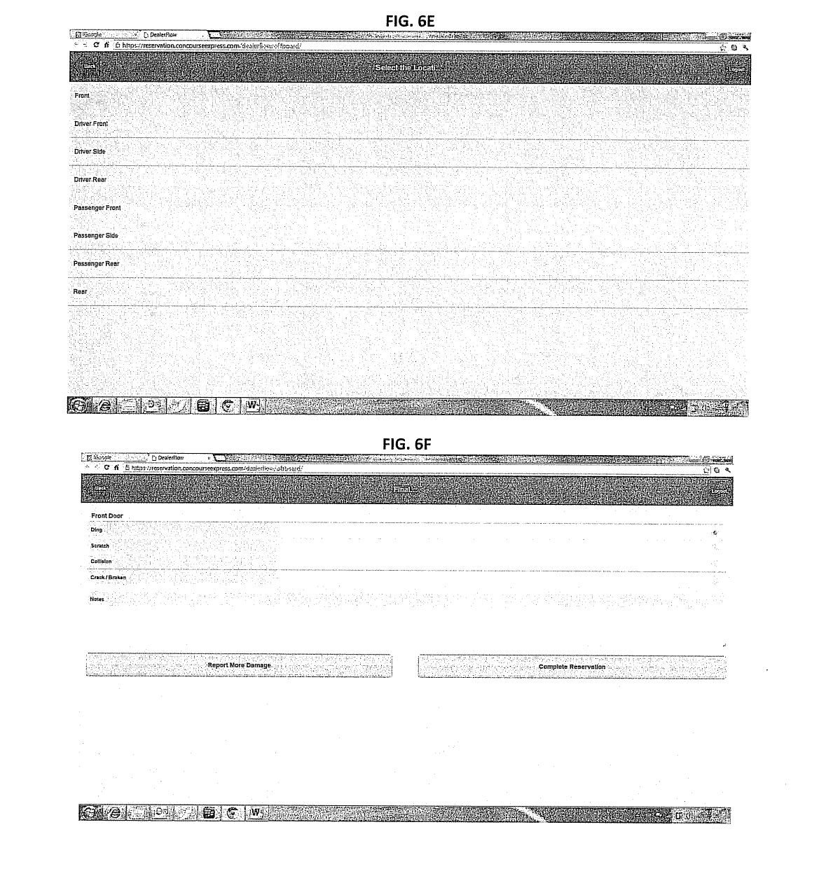

FIGS. 6A through 6F depict a particular embodiment of the off-boarding application. Upon return of the vehicle, a Porter uses an off-boarding application that quickly allows him to locate and display a customer reservation, as shown in FIG. 6A (at 410), by entering at least one of 4 identifying parameters: customer name; VIN; license tag number; or access card number. The reservation is then displayed in detail as shown in FIG. 6B. The Porter then runs through a series of check box diagnostics, as shown in FIG. 6C (at 420), including fuel, cleanliness, timeliness of return, vehicle damage, required maintenance or repair, and the presence of spare access cards and the Schedule A.

If damage needs to be recorded (at 430), the Porter may, in series, select the damaged part, location of the part, and type of damage, as shown in FIGS. 6D, 6E, and 6F, respectively. In this embodiment, damaged parts may include “Bumper”, “Door”, “Lens”, “Fender”, “Glass”, “Mirror”, “Quarter Panel”, “Tire”, “Wheel”, and “Other”, as depicted in FIG. 6D. Locations may include “Front,” “Driver Front”, “Driver Side”, “Driver Rear”, “Passenger Front”, “Passenger Side”, “Passenger Rear”, and “Rear”, as depicted in FIG. 6E. Types of damage may include “Ding”, “Scratch”, “Collision”, and “Crack/Broken”, as depicted in FIG. 6F. Photographs may be optionally taken for the records, using the camera 143.

Once the diagnostic has been completed, the Porter then ends the reservation by clicking “Complete” (at 440) which recycles the access card 125 back into the card pool and re-enters the vehicle 120 in the available, unreserved fleet (at 450). The Porter then drives the vehicle away from the service lane and to the car wash, and then the gas station should it need fuel before storing or staging the vehicle for its next reservation.

It is again noted that this section describes merely a specific exemplary embodiment of the invention, and does not limit the scope of the invention.

### 6. Advantages of the Invention

While not limited thereto, an advantage of an aspect of the invention is that it delivers convenience to the customer, enabling him to get to a vehicle more quickly after consulting with his SA with no wait at a rental counter.

While not limited thereto, an advantage of an aspect of the invention is that the SA may see other customers rather than escort individuals to their vehicles and perform tasks that require more time than they are allotted currently, thus reducing the need for additional personnel.

While not limited thereto, an advantage of an aspect of the invention is that separation of the selection stage from the reservation stage, and delay of vehicle selection until the actual boarding of the vehicle, decreases the chances that no vehicle will be available for the duration of a given time period.

While not limited thereto, an advantage of an aspect of the invention is that the regular documenting of damage into a VDHR after each use of the vehicle eliminates the need for the customer to conduct a walk-around with a SA or Lane Coordinator.

While not limited thereto, an advantage of an aspect of the invention is that reports may be easily and automatically generated which summarize the state and availability of the vehicle fleet as a whole or by specific vehicle, and which answer billing inquiries for specific reservations or for a driver in general.

While not limited thereto, an advantage of an aspect of the invention is that a fuel sensor may track the fuel level for a vehicle and notify the porter in advance of the need to refuel when the vehicle is returned.

While not limited thereto, an advantage of an aspect of the invention is that the interface is intuitive and easy to use for all parties, with a “wizard-ized” step-by-step process that eliminates user error and reduces the need for training.

### 7. Additional Uses

As previously noted, it will be readily apparent to those skilled in the art that the same invention may be applied to any business that lends or shares goods of common utility, including but not limited to rental car dealers, companies with a company car fleet, rental truck suppliers, rental equipment services, or public storage facilities, among many kinds of other businesses. In such instances, qualities related to vehicles may be altered in ways that may be appreciated by those skilled in the art to reflect differences between the lent good and vehicles. As one example, a public storage diagnostic would have no need to check a “fuel level” but might find the cleanliness of the storage unit important. As another example, rented equipment could be secured in containers, which open and allow retrieval of the equipment at 340.

While not limited thereto, it is understood that aspects of the system and method can be implemented using computer software and/or firmware encoded on one or more computer readable media or other non-transitory media readable by a processor and/or computer and implemented using one or more processors and/or computers.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of granting use of a vehicle from a plurality of vehicles, the method comprising:
(a) creating a reservation of a presently non-specified vehicle of a plurality of vehicles for a user for a specific period of time; and
(b) upon the user's selection of a specific vehicle of the plurality of vehicles, associating the specific vehicle with the user's reservation.

2. The method of claim 1, wherein (a) comprises:
(a)(1) receiving identifying information from the user;
(a)(2) storing reservation data of the reservation, including the identifying information, within a computer memory; and
(a)(3) associating an authentication object with the reservation in the computer memory.

3. The method of claim 2, wherein the authentication object is presented to the user for the first time at (a)(3).

4. The method of claim 2, wherein (b) comprises:
(b)(1) detecting the authentication object within a range of an object reader assigned to the specific vehicle;
(b)(2) determining the reservation associated with the authentication object; and
(b)(3) associating the reservation with the vehicle.

5. The method of claim 2, wherein the authentication object comprises an RFID access card, a security token key fob, or a digital communication.

6. The method of claim 1, further comprising: (c) allowing the user to use the specific vehicle.

7. The method of claim 6, wherein (b) and (c) occur effectively simultaneously.

8. The method of claim 6, wherein (c) comprises unlocking the vehicle and/or enabling the vehicle ignition.

9. The method of claim 1, wherein (a) comprises: (a)(4) creating and executing a contract agreeing to the reservation;
the method further comprising: (d) associating the contract with a schedule defining the specific vehicle for the contract.

10. The method of claim 2, further comprising, upon a return of the specific vehicle:
(e) running a diagnostic of the specific vehicle;
(f) closing the reservation; and
(g) deassociating the authentication object, the specific vehicle, and the reservation.

11. The method of claim 10, wherein (e) comprises:
(e)(1) examining a series of present diagnostic parameters related to the specific vehicle;
(e)(2) comparing present diagnostic parameters to previous diagnostic parameters in a diagnostic history; and
(e)(3) in a case where a change between present diagnostic parameters and previous diagnostic parameters is noted, updating the diagnostic history to reflect the change.

12. The method of claim 11, wherein the diagnostic parameters comprise one or more of the following: fuel level, tardiness of return, maintenance light status, presence of equipment, presence of vehicle documentation, and damage to the specific vehicle.

13. The method of claim 11, wherein the diagnostic parameters comprise damage to the specific vehicle, and updating the diagnostic history to reflect a change in damage comprises photographing images of the damage and/or recording a location of the damage, a type of damage, and a part damaged.

14. The method of claim 11, wherein (e) further comprises (e)(4) exporting part or all of the diagnostic history to a digital file and/or printing part or all of the diagnostic history to paper.

15. A computer readable medium encoded with processing instructions for implementing the method of claim 1 using one or more processors.

16. A system for managing use of a plurality of vehicles, the system comprising:
a plurality of vehicles;
at least one reader associated with each vehicle of the plurality of vehicles;
a plurality of authentication objects readable by the readers;
a server device comprising a processor, transceiver, and memory, the server device being in communication with the readers through the transceiver of the server device; and
an advisor device comprising a processor and transceiver, the advisor device being in communication with the server device through the transceiver of the advisor device;
wherein the advisor device creates a reservation in the memory of the server device and associates an authentication object with the reservation, without associating the reservation with a vehicle of the plurality of vehicles, and
wherein the authentication object, when brought within a range of one of the plurality of readers, associates, in the memory of the server device, the reservation associated with the authentication object with the vehicle associated with the reader.

17. The system of claim 16, further comprising a porter device comprising a processor and transceiver, the porter device being in communication with the server device through the transceiver of the porter device, wherein the porter device concludes one or more reservations stored in the memory of the server device.

18. The system of claim 17, wherein the porter device concludes a reservation by terminating the association between the vehicle, the authentication object, and the reservation in the server device memory.

19. The system of claim 17, wherein the porter device, before concluding a reservation, processes a checklist documenting one or more diagnostic parameters relating to the vehicle.

20. The system of claim 19, wherein:
the porter device further comprises a camera, and
processing the checklist comprises photographing new damage to the vehicle.

21. A method of processing the return of a lent or rented vehicle, comprising:
(a) examining a series of present diagnostic parameters related to a lent or rented vehicle;
(b) comparing present diagnostic parameters to previous diagnostic parameters in a diagnostic history; and
(c) in the case where a change between present diagnostic parameters and previous diagnostic parameters is noted, updating the diagnostic history to reflect the change.

22. The method of claim 21, wherein the diagnostic parameters comprise one or more of the following: fuel level, tardiness of return, maintenance light status, presence of equipment, presence of vehicle documentation, and damage to the vehicle.

23. The method of claim 21, wherein the diagnostic parameters comprise damage to the specific vehicle, and wherein updating the diagnostic history to reflect a change in damage to the vehicle comprises photographing images of the damage to the vehicle and/or recording a location of the damage, a type of damage, and a part of the vehicle damaged.

24. The method of claim 21, further comprising (d) exporting part or all of the diagnostic history to a digital file and/or printing part or all of the diagnostic history to paper.

25. A computer readable medium encoded with processing instructions for implementing the method of claim 21 using one or more processors.

26. A system for managing the return of a lent or rented vehicle, the system comprising:
one or more vehicles;
a server device comprising a processor, transceiver, and memory; and
a porter device comprising a processor and transceiver, the porter device being in communication with the server device through the transceiver of the porter device, wherein:
the porter device processes a checklist documenting one or more diagnostic parameters relating to the vehicle,
the server device receives and stores the checklist from the porter device, and
the porter device compares the checklist to one or more previous checklists stored on the server device.

27. The system of claim 26, wherein:
the porter device further comprises a camera, and
processing the checklist comprises photographing new damage to the vehicle.

28. A method of granting use of a vehicle of one or more vehicles, the method comprising:
(a) receiving identifying information from a user;
(b) storing reservation data of a reservation, including the identifying information, within a computer memory;
(c) associating a vehicle of the one or more vehicles with the reservation in the computer memory;
(d) creating a reservation of the vehicle for the user for a specific period of time;
(e) creating and executing a contract agreeing to the reservation.

29. The method of claim 28, wherein the receiving of the identifying information comprises reading information from a data-containing device.

30. The method of claim 29, wherein the data-containing device is an ID card containing readable data.

31. The method of claim 28, further comprising, at the conclusion of the reservation:
(f) running a diagnostic of the vehicle; and
(g) closing the reservation.

32. A computer readable medium encoded with processing instructions for implementing the method of claim 28 using one or more processors.

33. A system for managing use of one or more vehicles, the system comprising:
one or more vehicles;
at least one reader associated with each vehicle of the one or more vehicles;
a plurality of authentication objects readable by the readers;
a server device comprising a processor, transceiver, and memory, the server device being in communication with the readers through the transceiver of the server device; and
an advisor device comprising a processor and transceiver, the advisor device being in communication with the server device through the transceiver of the advisor device,
wherein the advisor device creates a reservation in the memory of the server device, associates a vehicle with the reservation, and creates a contract describing the reservation, and
wherein the server device stores data regarding the one or more vehicles, the data regarding each vehicle comprising a present state.

34. The system of claim 33, wherein:
the advisor device further comprises a card reader, which reads identifying data from one or more identifying data containing devices, and
the created reservation comprises the identifying data.

35. The system of claim 34, wherein the card reader further reads financial data from one or more financial data containing devices.

36. The system of claim 33, wherein the data regarding each vehicle further comprises a list of data regarding past and present reservations.

37. The system of claim 33, further comprising a porter device comprising a processor and transceiver, the porter device being in communication with the server device through the transceiver of the porter device, wherein the porter device concludes one or more reservations stored in the memory of the server device.

38. The system of claim 37, wherein:
the data on each vehicle stored on the server further comprises a diagnostic history comprising one or more diagnostic checklists documenting one or more diagnostic parameters relating to the vehicle,
the porter device processes a new diagnostic checklist and compares the new diagnostic checklist to the one or more diagnostic checklists stored on the server device, and
the server device receives the new diagnostic checklist from the porter device and stores it to the diagnostic history.
